(19) United States
(12) Patent Application Publication
(10) Pub. No.: US 2025/0383858 A1
(43) Pub. Date: Dec. 18, 2025

(54) Multi-Phase Application Profiling and Compilation

(71) Applicant: International Business Machines Corporation, Armonk, NY (US)

(72) Inventors: Abdulrahman Alattas, Scarborough (CA); Spencer Aaron Comin, Markham (CA); Vijay Sundaresan, North York (CA); Danja Papajani, Toronto (CA); Sibin Fan, Markham (CA); Dan Stingaciu, Holland Landing (CA); Joran S.C. Siu, Thornhill (CA)

(21) Appl. No.: 18/742,206

(22) Filed: Jun. 13, 2024

(51) Int. Cl. G06F 8/65; G06F 8/71

(52) U.S. Cl. CPC G06F 8/65; G06F 8/71

(57) ABSTRACT

A computer implemented method manages application execution. A processor set monitors an execution of an application. The processor set collects current profile information for the application in response to detecting a phase change in the execution of the application. The processor set compares the current profile information with previously collected profile information for a number of existing profiles. The processor set patches the application to use an existing specialized body that is an optimized version of a general body that has been optimized for the previously collected profile information for an existing profile in the number of existing profiles in response to the current profile information matching the previously collected profile information for the existing profile.

### BACKGROUND

The disclosure relates generally to an improved computer system and more specifically to increasing the performance of applications with multiple phases.

Optimizing execution of code and application is performed for a number of different reasons. For example, the optimization can increase performance of an application. This increase in performance can have different aspects. For example, the performance can be related to execution time, resource consumption, throughput, reliability, latency, and other types of metrics.

For example, optimization can reduce execution time for tasks performed by applications such as those for gaming, financial trading, or other purposes. Additionally, a more efficient use of resources such as memory, disk, the processors, and network resources can occur. This efficient use can include a reduction in the use of memory, disk space, processor use, and network resources. In yet another example, the optimization can also increase user experience a lower latency that provides faster responsiveness to user requests.

In optimizing the code for an application, the code can be instrumented to generate information about the behavior of the code. The application with the instrumented code is run and profile information is collected from running this instrumented code. This profile information is used to identify one or more optimizations for the code. This code with the optimizations is then used in the application to increase performance of the application.

### SUMMARY

According to one illustrative embodiment, a computer implemented method manages application execution. A processor set monitors an execution of an application. The processor set collects current profile information for the application in response to detecting a phase change in the execution of the application. The processor set compares the current profile information with previously collected profile information for a number of existing profiles. The processor set patches the application to use an existing specialized body that is an optimized version of a general body that has been optimized for the previously collected profile information for an existing profile in the number of existing profiles in response to the current profile information matching the previously collected profile information for the existing profile. According to other illustrative embodiments, a computer system and a computer program product for managing application execution are provided.

### BRIEF DESCRIPTION OF THE DRAWINGS

FIG. 1 is a block diagram of a computing environment in accordance with an illustrative embodiment;

FIG. 2 is a block diagram of an application execution environment in accordance with an illustrative embodiment;

FIG. 3 is an illustration of profiles associated with phases in accordance with an illustrative embodiment;

FIG. 4 is an illustration of calls to specialized bodies based on a phase in an application in accordance with an illustrative embodiment;

FIG. 5 is a flowchart of a process for a method lifecycle in accordance with an illustrative embodiment;

FIG. 6 is an illustration of an optimization for a general body in accordance with an illustrative embodiment;

FIG. 7 is an illustration of a specialized body in accordance with an illustrative embodiment;

FIG. 8 is an illustration of codes for different phases in accordance with an illustrative embodiment;

FIG. 9 is an illustration of codes for detecting a phase change in accordance with an illustrative embodiment;

FIGS. 10A-10B are a dataflow diagram for phase changes in accordance with an illustrative embodiment;

FIG. 11 is a flowchart of a process for application execution in accordance with an illustrative embodiment;

FIG. 12 is a flowchart of a process for application execution in accordance with an illustrative embodiment;

FIG. 13 is a flowchart of a process for creating a new specialized body for application in accordance with an illustrative embodiment;

FIG. 14 is a flowchart of a process for saving profile information in accordance with an illustrative embodiment;

FIG. 15 is a flowchart of a process for detecting a phase change in accordance with an illustrative embodiment;

FIG. 16 is a flowchart of a process for collecting current profile information in accordance with an illustrative embodiment; and

FIG. 17 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

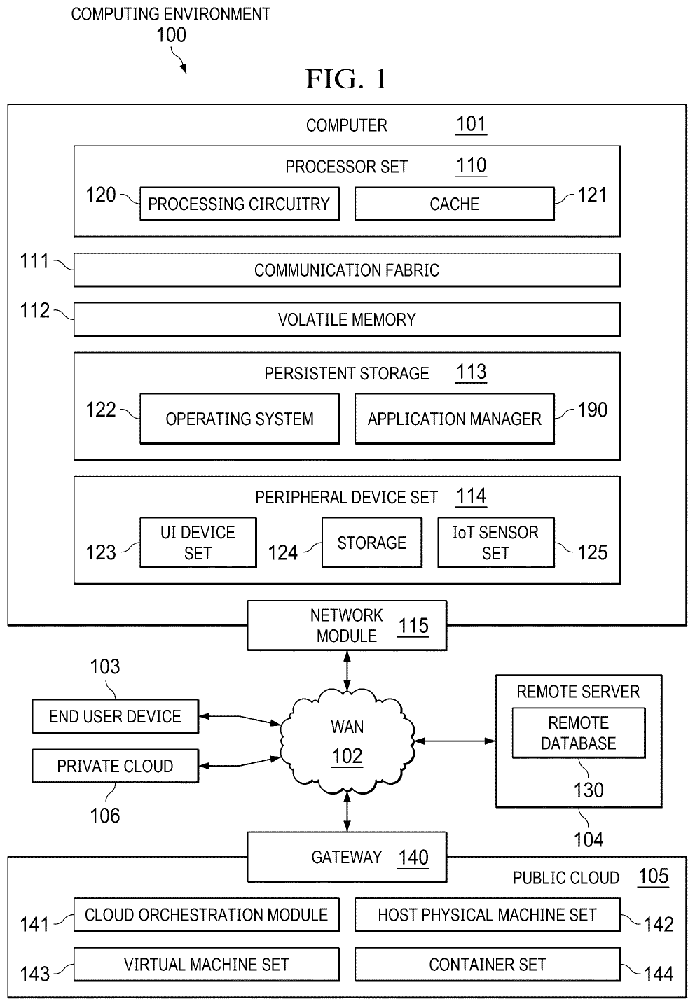

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as application manager 190. In addition to application manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and application manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in application manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in application manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. Code in an application can be instrumented and the instrumented code can be compiled and run. This code can be one or more methods in the application. Instrumented code provides information about the behavior of the code that is running for the application. This information forms a profile for the application. A number of optimizations are identified for the code using the information in the profile. The code can be modified with these optimizations to form optimized code. The application is compiled with the optimized code and run. For example, when the code are in methods, this profiling and optimization can be run by a just in time (JIT) compiler.

Current techniques do not take into account that applications can have multiple phases. For example, an application that is a scientific program can have a calculation phase and an analysis phase. As another example, an artificial intelligence system can have a model and data loading phase and a calculating phase that generates results. Additionally, a phase can be based on the time of day. A function may be different for different times of the day. For example, a webpage can be different languages based on the time of day. The webpage may be in a first language during a first part of the day and in a second language during a second part of the day.

With multiphase applications, optimizations of code using a single profile can result in suboptimal performance of the code in each phase of the application. As a result, the entire program may run with a lower level of performance.

Thus, illustrative examples provide a computer implemented method, apparatus, system, and computer program product for managing execution of an application. For example, a computer implemented method runs an application, a processor set monitors an execution of an application. The processor set collects current profile information for the application in response to detecting a phase change in the execution of the application. The processor set compares the current profile information with previously collected profile information for existing profiles. The processor set patches the application to use an existing specialized body that is an optimized version of a general body that has been optimized for the previously collected profile information for an existing profile in the profiles in response to the current profile information matching the previously collected profile information for the existing profile.

In these examples, different optimizations of a body can be present and stored in association with profiles. These profiles are related to the phase of execution of an application. In these examples, when the current profile information sufficiently matches previously collected profile information for existing profiles, the optimized body for profile information in the existing profile matching the current profile information can be used to increase the performance of the application for that particular phase.

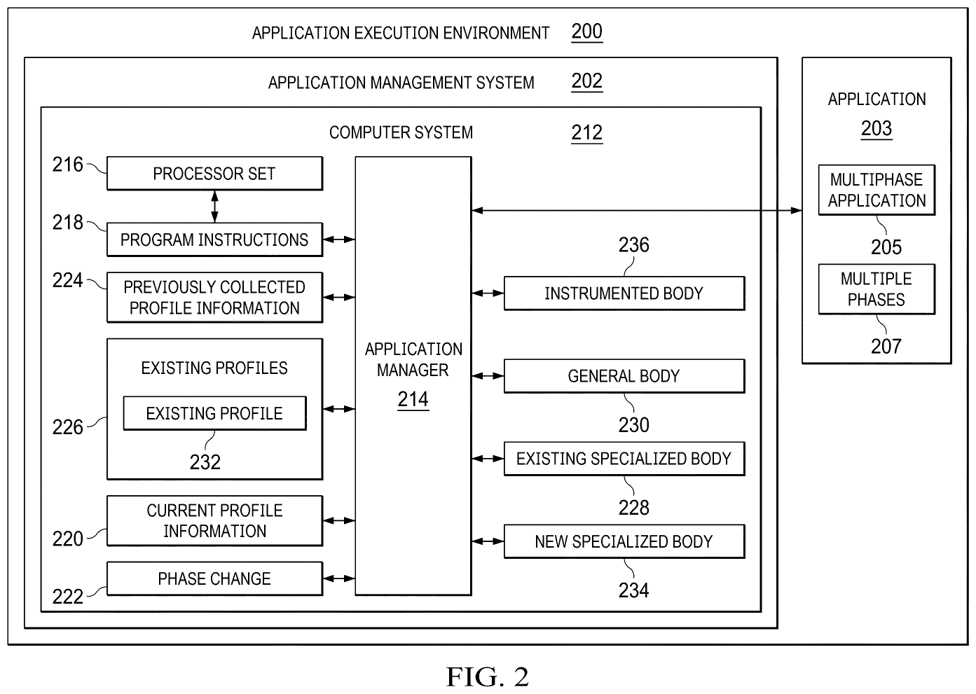

With reference now to FIG. 2, a block diagram of an application execution environment is depicted in accordance with an illustrative embodiment. In this illustrative example, application execution environment 200 includes components that can be implemented in hardware such as the hardware shown in computing environment 100 in FIG. 1. Application management system 202 can operate to manage the execution of application 203. In this example, application 203 can have multiple phases 207 that occur during execution of application 203. With the occurrence of multiple phases 207, application 203 is multiphase application 205.

In this illustrative example, application management system 202 comprises application manager 214 and computer system 212. Application manager 214 is located in computer system 212. Application manager 214 may be implemented using application manager 190 in FIG. 1.

Application manager 214 can be implemented in software, hardware, firmware or a combination thereof. When software is used, the operations performed by application manager 214 can be implemented in program instructions configured to run on hardware, such as a processor unit. When firmware is used, the operations performed by application manager 214 can be implemented in program instructions and data and stored in persistent memory to run on a processor unit. When hardware is employed, the hardware can include circuits that operate to perform the operations in application manager 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes processor set 216 that is capable of executing program instructions 218 implementing processes in the illustrative examples. In other words, program instructions 218 are computer-readable program instructions. Processor set 216 is an example of processor set 110 in FIG. 1.

As used herein, a processor unit in processor set 216 is a hardware device and is comprised of hardware circuits such as those on an integrated circuit that respond to and process instructions and program code that operate a computer. Processor set 216 can be a number of processor units that can be implemented using processor set 110 in FIG. 1. The processor units can also be referred to as computer processors. When processor set 216 executes program instructions 218 for a process, processor set 216 can be one or more processor units that are in the same computer or in different computers. In other words, the process can be distributed between processor units in processor set 216 on the same or different computers in computer system 212. Further, processor set 216 can include the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

Although not shown, processor set 216 can also include other components in addition to the processor units or processing circuitry. For example, processor set 216 can also include a cache or other components used with processor units or other processing circuitry.

In this illustrative example, application manager 214 operates to manage the execution of application 203. For example, the application manager 214 monitors an execution of application 203. In this example, the monitoring is to detect a phase change between multiple phases 207 that can occur in application 203.

Application manager 214 collects current profile information 220 for application 203 in response to detecting phase change 222 in the execution of the application 203. In this example, profile information comprises at least one of a function call, a branch, a system call, or an expected value, or other information about the behavior of an application.

In this illustrative example, in collecting current profile information 220, application manager 214 compiles general body 230 with profiling instrumentation to form instrumented body 236. In this illustrative example, a body is code that is executed. This body can be a method having a class, a function, a procedure, or some other construct that includes code for execution. In this example, general body 230 is a version of the code that has not been optimized.

Application manager 214 patches application 203 to call instrumented body 236. Application manager 214 runs application 203 using instrumented body 236. Application manager 214 collects current profile information 220 in response to running application 203 using instrumented body 236.

In this example, application manager 214 compares current profile information 220 with previously collected profile information 224 for existing profiles 226. Further in this example, application manager 214 patches (updates) application 203 to use an existing specialized body 228 that is an optimized version of a general body 230 that has been optimized for previously collected profile information 224 for existing profile 232 in the existing profiles 226 in response to current profile information 220 matching previously collected profile information 224 for existing profiles 226. In this example, the calls patched in application 203 are to general body 230. The patching changes a call to use existing specialized body 228 instead of general body 230.

Application manager 214 can then continue execution of application 203 using existing specialized body 228. For example, application manager 214 runs application 203 that has impact using existing specialized body 228. In this example, the pattern can occur as calls for the body are encountered. In some cases, the entire application can be patched at the same time to direct calls to the body to existing specialized body 228. For example, the calls in application 203 can be to general body 230 for which existing specialized body 228 is an optimized version of general body 230.

In another example, current profile information 220 does not match any of the number of existing profiles 226. With this example, application manager 214 compiles general body 230 with optimization for current profile information 220 to form new specialized body 234 in response to current profile information 220 not matching previously collected profile information 224 for the number of existing profiles 226. In other words, changes are made to general body 230 to optimize the performance of the code in general body 230 for current profile information 220.

Application manager 214 patches application 203 to use new specialized body 234. Further in this example, application manager 214 saves current profile information 220 as part of previously collected profile information 224. Additionally, application manager 214 associates current profile information 220 with new specialized body 234.

In these illustrative examples, the different specialized bodies are saved and not discarded in case these specialized can be used at a later time when phase change 222 occurs. In these examples, application 203 can be patched to call different specialized bodies that are optimized for the profile in the current phase resulting from phase change 222. The performance of computer system 212 in executing application 203 increases with this optimization. Further, the profile information is saved in previously collected profile information 224 that enables comparing current profile information 220 with previously collected profile information 224.

In these illustrative examples, phase change 222 is indicated by at least one of a software event, a hardware event, or an external condition. For example, a software event that is phase change 222 can be a change in path frequency, a variable that is outside of a selected range, a variable that has a selected value or other software event. A hardware rate that can include, for example, a cache miss, a branch prediction, an interprocess communication (IPC), or other computing events. An external condition can be, for example, a particular time, a location, a weather condition, or some other condition that is external to the computer system.

Indication of phase change 222 may occur when one of these events occur greater than some threshold level or outside of the expected range. In this illustrative example, a body can be instrumented to generate an indication of when particular event or events occur for the body. An indication of the phase change may occur when one of these events occur greater than some threshold level or outside of the expected range.

For example, with a cache, data are pulled from memory into the processor cache for a faster retrieval time during application execution. The cache has a limited capacity. As a result, the cache stores the most frequently and recently used data.

When phase change 222 occurs from a change in application behavior an increase in the cache-miss rate may be detected given that a different phase may use a different set of data from the memory that was not previously stored in the cache. In this case, the data used by the application are not in the cache and needs to be fetched from memory. This increase in cache misses can indicate the change in phase.

As another example, during specific hours of day most payments in an application for an international payment system is in United States dollars (USD). With this example, the application uses a specialized body that has a fast-path for that currency that is USD while a slow-path is used for other currencies. The fast path is a specialized body that is optimized for currency in the form of USD. The slow path is not optimized for a particular currency. With this example, at a different time, most payments processed by the application are in yen as a currency. This change in path frequency indicates a phase change. The body can be optimized to have a fast path for yen. This body with the optimization is a new specialized body. In another example, an existing specialized body optimized to have a fast path for yen can be present. This existing specialized body can be used without having to perform another optimization. In this case, the application can be patched to use this existing specialized body.

In one illustrative example, one or more solutions are present that overcome a problem with optimizing a body in an application having multiple phases. Optimizing embodiment applications having multiple phases can result in suboptimal performance for one or more of the phases. As a result, the optimization of a body in the application may have a lower performance as compared to the execution of the body without an optimization.

In these examples, specialized bodies with optimizations for particular phases are used to ensure increased performance for applications with multiple phases. For example, application manager 214 can generate specialized bodies that are specific for each phase occurring in an application. In this illustrative example, the application can be monitored for phase changes and a specialized body is created for each new phase. Profile information is collected for the application each time a new phase is detected. This collected profile information is current profile information that is compared to previously collected profile information for existing profiles to determine whether matches are present. If a match is present, then the specialized body for the existing profile with previously collected profile information matching the current profile information is used in running the application. This specialized body is an optimized version of a general body optimized based on the previously collected profile information for the existing profile matching the current profile information.

If a matching profile is not present in the existing profiles, then the process optimizes the general body to create a new specialized body using the current profile information. The new specialized body is saved. The current profile information is saved as a new profile in association with the new specialized body.

In these illustrative examples, the specialized bodies are not discarded when a new specialized body is created. As a result, increased performance can also occur through not needing to optimize the general body with the current profile information in response to a new phase occurring that is a repeat of a previous phase for which a specialized body has been generated from the general body.

Computer system 212 can be configured to perform at least one of the steps, operations, or actions described in the different illustrative examples using software, hardware, firmware or a combination thereof. As a result, computer system 212 operates as a special purpose computer system in which application manager 214 in computer system 212 manages application execution. In particular, application manager 214 transforms computer system 212 into a special purpose computer system as compared to currently available general computer systems that do not have application manager 214.

This special purpose computer has increased performance as compared to general computer systems that do not have application manager 214. For example, the performance of computer system 212 in executing an application increases because a general body is optimized to form a specialized body for each phase of a multiphase application that can operate in multiple phases during execution of the application. As a result, issues with optimizing a body resulting in decreased performance in phase changes does not occur as compared to currently used optimization techniques. Further, by saving specialized bodies from previous optimizations for different phases, time is saved in not needing to perform an optimization using current profile information detected in response to a phase change. Instead, when that current profile information matches previously collected profile information for the existing profile, an existing specialized body for that existing profile can be used by patching the application such that calls are directed to that existing specialized body.

As result, compiling a general body to have optimizations for a current profile information is unnecessary when a match is present with previously collected profile information for an existing profile. Further, other performance increases can occur through patching calls to be directed to the specialized body in response to a call in the application being made to the current body being called. This current body can be a base body or another specialized body created with optimizations for another profile in a different phase. As another example, in monitoring the application execution, a slow path in the specialized body can be instrumented to detect when a phase change occurs. The slow path is a path or branch in the specialized body is not expected to be taken very often as compared to the fast path in the specialized body.

The illustration of application execution environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, application 203 is shown as a component that can run on a computer system other than computer system 212. In another illustrative example, application 203 can run in computer system 212. For example, application 203 can run on one computer in computer system 212 while application manager 214 runs on another computer in computer system 212.

Further, application manager 214 is shown as a standalone component. Application manager 214 can operate with a compiler. In another example, application manager 214 can be integrated as part of a compiler. This compiler can be, for example, a just-in-time (JIT) compiler or other suitable compiler. Further, one or more general embodiments can be monitored and optimized using the different processes in addition to general body 230 in FIG. 2.

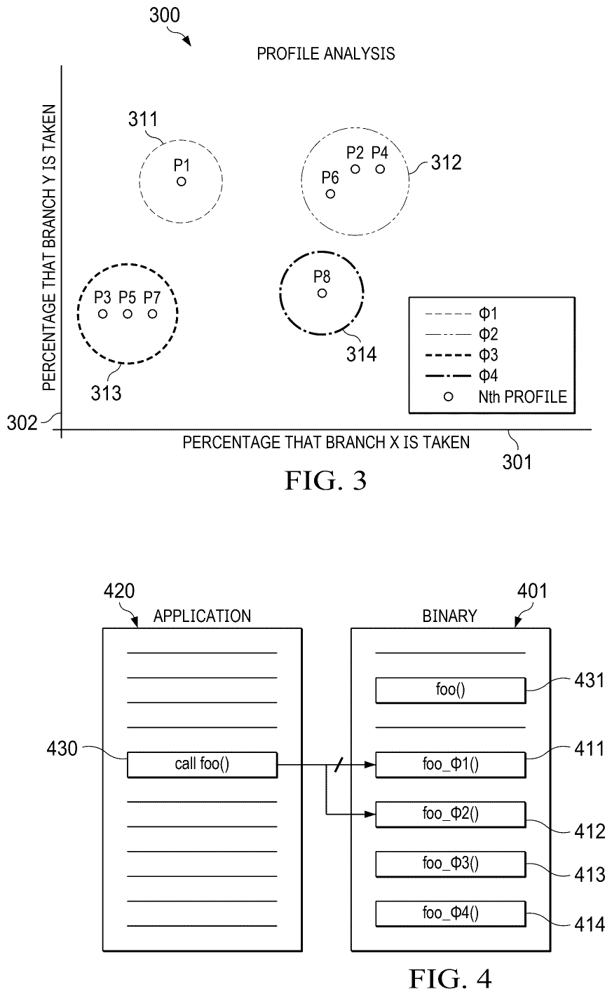

With reference next to FIG. 3, an illustration of profiles associated with phases is depicted in accordance with an illustrative embodiment. In this illustrative example, graph 300 illustrates profiles that are clustered to identify phases. In this example, x-axis 301 is the percentage that branch X is taken and y-axis 302 is the percentage that branch Y is taken by a general body in this example. The profile information can be determined from instrumenting the general body. The profile information can be collected during a phase of the application. In this example, the phases for the application comprise phase Φ1 311, phase Φ2 312, phase Φ3 313, and phase Φ4 314.

As depicted, profile information has been detected for profile P2, profile P3, profile P4, profile P5, profile P6, and profile P7. Each of these profiles can belong to one of the four phases in this example. The identification of the phases for each of the profiles can be performed by analyzing the profile information for the profiles. For example, this analysis can be performed using K clustering.

As depicted from the statistical analysis, profile P1 is located in phase Φ1 311 and profile P8 is located in phase Φ314. Profile P2, profile P4, and profile P6 are located in phase Φ2 312. In this example, profile P3, profile P5, and profile P7 are located in phase Φ3 313.

With reference to FIG. 4, an illustration of calls to specialized bodies based on a phase in an application is depicted in accordance with an illustrative embodiment. Each of these phases can have a specialized method. Thus, with four phases, four different specialized methods are present. These methods are derived from the same general method. Each of the specialized methods are optimized using the profile information associated with those phases.

As depicted, binary 401 includes specialized bodies for the phases depicted in FIG. 3. In this example, specialized body foo_phase Φ1( ) 411 is for phase Φ1 311; specialized body foo_phase Φ2( ) 412 is for phase Φ2 312; specialized body foo_phase Φ3( ) 413 is for phase Φ3 313; and specialized body foo_phase Φ4( ) 414 is for phase Φ4 314. Each of these specialized bodies is an optimized form of general body foo( ) 431. In this example, general body foo( ) 431 is a general body and has not optimized for any particular phase.

As depicted, application 420 had a call to foo( ) 430 that was patched to point to specialized body foo_phase Φ1( ) 411. In this example, a phase change occurred and the new phase identified is phase Φ2( ) 312. With this example, the application 420 has been patched such that call foo( ) 430 changed from being pointed to specialized body foo_phase Φ1( ) 411 to specialized body foo_phase Φ2( ) 312.

This change in specialized bodies enables optimizing the execution of the application for different phases. These specialized bodies are saved and not discarded as phase changes occur. As a result, recompiling optimized versions of general body foo( ) 431 is not needed. However, if a new previously unknown phase is identified, then a new specialized version can be compiled from general body foo( ) 431 using the profile information for that new phase.

For example, if the phase changes from phase Φ2( ) 312 to phase Φ4 314, call foo( ) 430 can be patched to now point to specialized body foo_phase Φ4( ) 414.

The illustration of the general body and specialized bodies have been provided as examples to illustrate one manner in which an illustrative example can be implemented and not meant to limit the manner in which other illustrative examples can be implemented, for example, with only two specialized bodies being needed rather than four. In yet another illustrative example, general body foo( ) 431 is a generalized form of the specialized bodies. This body can be instrumented for collecting profile information and does not need to be retained.

The illustration of calls to specialized bodies is provided as an example and not meant to limit the manner in which other illustrative examples can be implemented. Other examples can have other numbers of phases such as two phases, three phases, seven phases, or some other number of phases. Further, in other illustrative examples the specialized bodies can take other executable forms such as bytecodes in addition to or in place of binary 401.

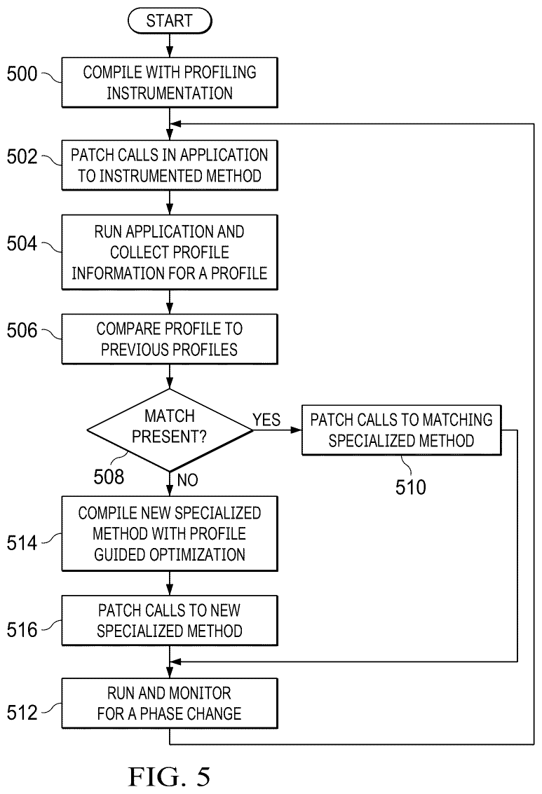

With reference next to FIG. 5, a flowchart of a process for a method lifecycle is depicted in accordance with an illustrative embodiment. The process in FIG. 5 can be implemented in hardware, software, or both. When implemented in software, the process can take the form of program instructions that are run by a processor set located in one or more hardware devices in one or more computer systems. For example, the process can be implemented in application manager 214 in computer system 212 in FIG. 2. In this example, the process manages calls to a body that is for a method.

In this example, this process can be initiated in response to the execution of the method. The method can be selected as one that is called some threshold number of times. For example, 1000 calls to a method can be a threshold level for initiation of the process. In other examples, other numbers of calls can be selected. Further, when this process is implemented in a just-in-time (JIT) compiler, the compiler can decide whether the method should be optimized using this process.

Further, this process can be initiated in response to different events that do not include a phase change. For example, an application manager may decide to initiate the process in this figure the first time a method has been called or after a method has been called 1000 times. In this example, the application manager can decide to invoke the process in this figure without using a phase change.

The process begins by compiling the method with profiling instrumentation (step 500). In step 500, code is added to the method and the method is compiled from instructions and program language to an executable form of the method. This executable form can be, for example, binary code or bytecodes.

The process patches the application to the instrumented method (step 502). In other words, calls to the method and other portions of the application are changed to call this instrumented method rather than the original method. In this example, the executable code for the originally compiled method is called a general body.

The process runs the application and collects profiling information for a profile (step 504). In step 504, the application is run until the method has been called a sufficient number of times to collect profile information to form an accurate profile for the phase. In another example, the collection of profile information can be performed until the numbers or values for the profile information are considered stable.

The process compares the profile to previous profiles (step 506). In step 506, previous profiles may be absent if this is the first time the process is run. In this illustrative example, the profile information for the profiles can be represented as vectors. These vectors can be analyzed using statistical methods to determine whether a match is present. In on example, the comparison in step 506 can be performed using the clustering mechanism such as K clustering. This clustering mechanism can be used to determine whether the profile is sufficiently close to be clustered or grouped with one or more previous profiles. This grouping is used to determine whether a match is present.

In one illustrative example, the method can have an element in the vector for each branch in the method. If the method has two branches, then the vector has two elements. For example, element x can be the number of times branch X has been taken and element y can be the number of times branch Y has been taken.

In another example, the vector can include an element for each branch in the method. Further, the settlement can include another element for the total number of calls. This additional element can be used to determine the number of times a branch was not taken and used to calculate the ratio of taken versus not taken branches. This ratio can be used when profiles do not include the same number of calls. These vectors can be compared in step 506 to determine the distance between the vectors. With an exact match between two vectors, the distance is zero.

A determination is made as to whether a match is present between the profile and any of the previous profiles (step 508). In this example, a match can be present when the distance is zero or that the distance is within some threshold value. In other words, an exact match does not have to be present for two profiles to match each other. For example, a match to be based on whether the profile is considered as part of a cluster for a previous profile.

If a match is present, calls in the application are patched to the matching specialized method (step 510). In step 510, all of the calls in the application can be patched to point to the matching specialized method. In some illustrative examples, dispatching can be performed dynamically during execution of the application. In other words, execution of the call can occur when that call is made in executing the application.

The process runs the application and monitors for a phase change (step 512). In response to detecting phase change, the process returns to step 502 as described above.

With reference again to step 508, if a match is not present between the profile and any of the previous profiles, the process compiles a new specialized method with profile guided optimization (step 514). In step 514, a new method is compiled with optimizations based on the profile. In this case, the profile is not present for the particular phase. As a result, the new specialized method can be optimized for this new phase. For example, the method can be compiled to have a fast path to another method or function rather than using the current techniques to identify methods or functions on a call.

The process patches calls in the application to the new specialized method (step 516). The process then proceeds to step 512 as described above.

Thus, the process can continue as additional phase changes are detected.

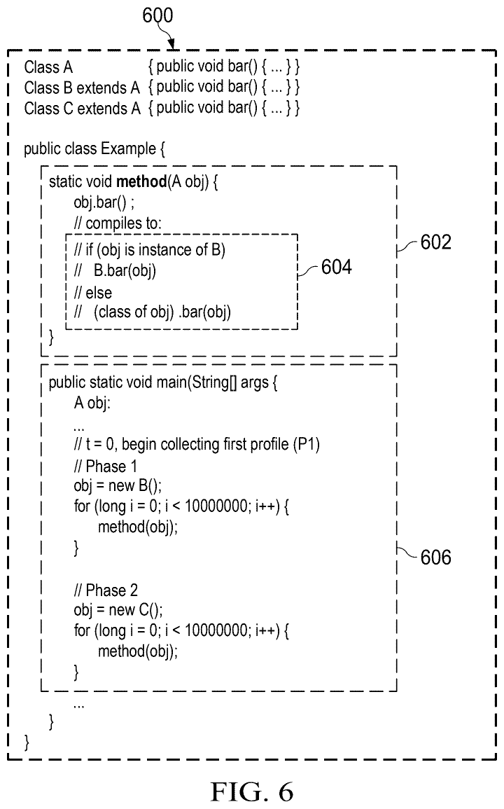

With reference next to FIG. 6, an illustration of an optimization for a general body is depicted in accordance with an illustrative embodiment. In this illustrative example, program instructions 600 include general body 602 that can be an example of general body 230 in FIG. 2. In this illustrative example, general body 602 can be an example of general body foo( ) 431 in FIG. 4.

General body 602 is a method that includes program instructions for execution. In this illustrative example, the method for general body 602 includes an object in class “A” as a parameter. When general body 602 is executed, the method for general body 602 calls method “bar( )” that is defined based on different classes such as class “A”, class “B”, or class “C”.

In this example, profile information is collected during execution of general body 602. In FIG. 6, optimization 604 includes program instructions that can be added to general body 602 for optimizing performance for program instructions 600. For example, program instructions in optimization 604 can be used as optimization for general body 602 when the profile information for general body 602 indicates that the object for the method in program instructions 600 usually belongs to class “B”.

In this illustrative example, optimization 604 includes an IF statement that determines whether the object used as parameter for the method in program instructions 600 belongs to class “B”. If the object used as parameter for the method in program instructions 600 belongs to class “B”, method “B.bar( )” is called directly for optimizing performance for program instructions 600. On the other hand, an ELSE statement is executed when the object used as parameter for the method in program instructions 600 does not belong to class “B”. During the execution of the ELSE statement, the process identifies the class for the object and executes method “obj.bar( )” based on the identified class.

As a result, a specialized body is formed for program instructions 600 by adding optimization 604 to general body 602. In this illustrative example, the IF statement can be an example of a fast path in the specialized body and the ELSE statement can be an example of a slow path in the specialized body. In other words, optimization 604 can include a fast path for another method called by general body 602 that is optimized. In this illustrative example, program instructions 600 also include portion 606, which shows codes in different phases of an application for program instructions 600.

In the illustration of program instructions 600, general body 602 and optimization 604 in FIG. 6 are not meant to imply limitations to the manner in which other illustrative examples can be implemented. For example, program instructions 600, general body 602, and optimization 604 can be written in other programming languages, mainframe languages, or any suitable machine understandable languages.

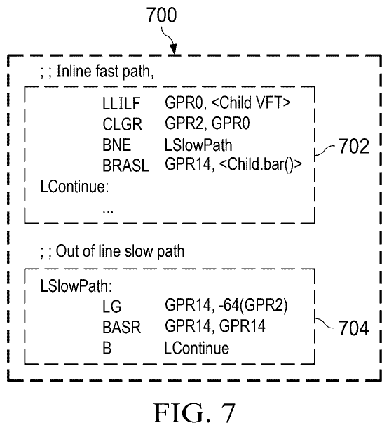

With reference next to FIG. 7, an illustration of a specialized body is depicted in accordance with an illustrative embodiment. In FIG. 7, specialized body 700 includes fast path 702 and slow path 704. In this illustrative example, specialized body 700 can be an example of existing specialized body 228 and new specialized body 234 in FIG. 2. In this illustrative example, specialized body 700 can also be an example of specialized body foo_phase Φ1( ) 411, specialized body foo_phase Φ2( ) 412, specialized body foo_phase Φ3( ) 413, or specialized body foo_phase Φ4( ) 414 in FIG. 4.

In FIG. 7, specialized body 700 is written in a mainframe language for executing method “obj.bar( )”. In this illustrative example, fast path 702 includes loading virtual function table (VFT) for class “child”. In this example a virtual function table (VFT) is a lookup table for a method. Each class with virtual functions has its own VFT. This VFT maps a function call to the correct function implementation based on the actual object type at runtime. When a class method is declared as virtual, the compiler sets up a VFT entry for that method. At runtime, when a virtual method is called on an object, the corresponding function pointer from the VFT of that object's class is used to invoke a method implementation.

In fast path 702, the current VFT pointer in register “GPR2” is compared with VFT pointer for class “child”. If the current VFT pointer in register “GPR2” and VFT pointer for class “child” are equal, method “child.bar( )” is called directly for optimizing performance of applications. In other words, fast path 702 includes calling method “child.bar( )” directly when the object for method “obj.bar( )” belongs to class “child”.

On the other hand, if the current VFT pointer in register “GPR2” and VFT pointer for class “child” are not equal, specialized body 700 proceeds based on slow path 704. In slow path 704, the class of object for executing method “obj.bar( )” is identified by looking up the VFT. As a result, method “obj.bar( )” is executed based on the class of object identified. In this illustrative example, specialized body 700 allows for efficient execution by first attempting a direct call using fast path 702 and falling back to a more generic lookup using slow path 704 when fast path 702 fails.

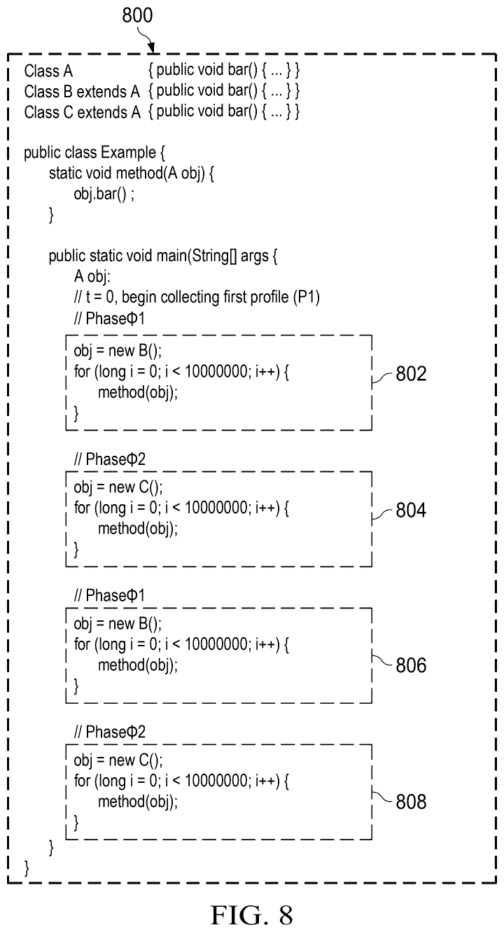

With reference next to FIG. 8, an illustration of program instructions for different phases is depicted in accordance with an illustrative embodiment. As depicted, an application can have multiple repeating phases that need a specific fast path for each phase. In program instructions 800, portion 802 shows program instructions for phase Φ1 of an application for program instructions 800. In portion 802, “method” in program instructions 800 will be compiled with a fast path for object “obj” that belongs to class “B” during phase Φ1 of the application for program instructions 800.

Portion 804 shows program instructions for phase Φ2 of the application for program instructions 800 after a phase change from phase Φ1 to phase Φ2. In portion 804, “method” in program instructions 800 will be compiled with a fast path for object “obj” that belongs to class “C” during phase Φ2 of the application for program instructions 800.

Further, portion 806 shows codes for phase Φ1 of the application for program instructions 800 after a phase change from phase Φ2 back to phase Φ1 for the application. In this illustrative example, program instructions for portion 802 are identical as program instructions for portion 806 because a new body does not have to be compiled for “method” and the application can simply patch to the specialized body generated for “method” in portion 802 during phase Φ1.

In addition, portion 808 shows program instructions for phase Φ2 of the application for program instructions 800 after a phase change from phase Φ1 to phase Φ2 for the application for the second time. In a similar fashion, program instructions for portion 804 are identical as program instructions for portion 808 because a new body does not have to be compiled for “method” and the application can simply patch to the specialized body generated for “method” in portion 804 during phase Φ2.

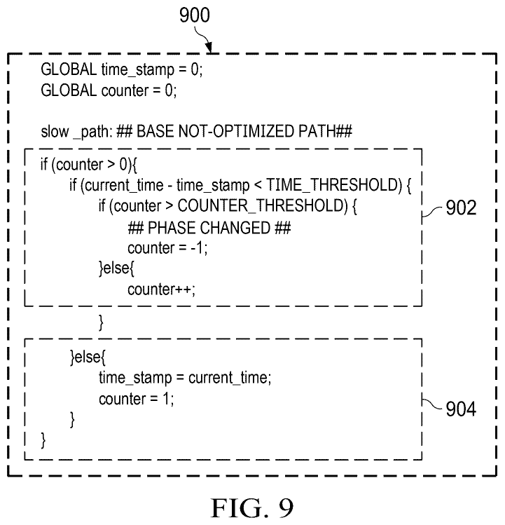

With reference next to FIG. 9, an illustration of codes for detecting a phase change is depicted in accordance with an illustrative embodiment. In this illustrative example, program instructions 900 can be an example of program instructions for detecting phase change 222 in FIG. 2.

Program instructions 900 illustrates a counter that can be inserted into a slow path in a specialized body to determine the frequency of execution for the slow path. In this illustrative example, the frequency of slow path execution is measured by repeated executions in a short period of time. For example, portion 902 in program instructions 900 includes a time threshold “TIME_THRESHOLD” to define the short period of time and a counter threshold for determining frequency of slow path execution. In this illustrative example, program instructions 900 detects a phase change when slow path executions exceed a count greater than the counter threshold within the time threshold. Otherwise, the counter for program instructions 900 increments by 1.

On the other hand, portion 904 shows codes for resetting the counter when the time threshold is reached. In this illustrative example, if program instructions 900 runs for a time that exceeds the time threshold, portion 904 in program instructions 900 resets the counter to 1 and continues to determine frequency of execution for the slow path for identifying phase changes.

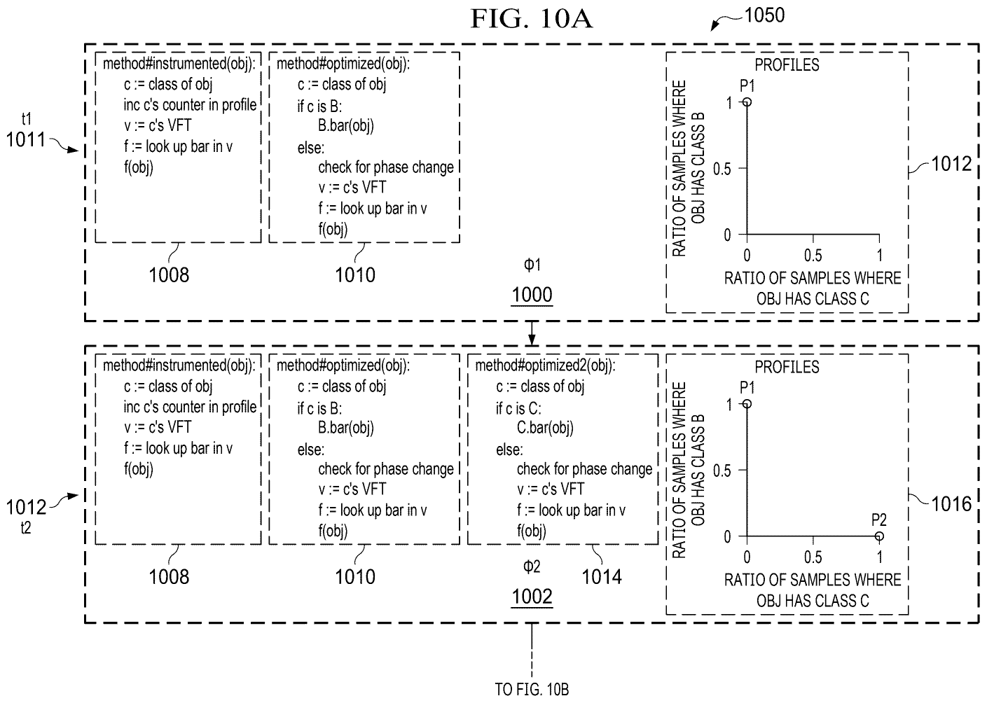

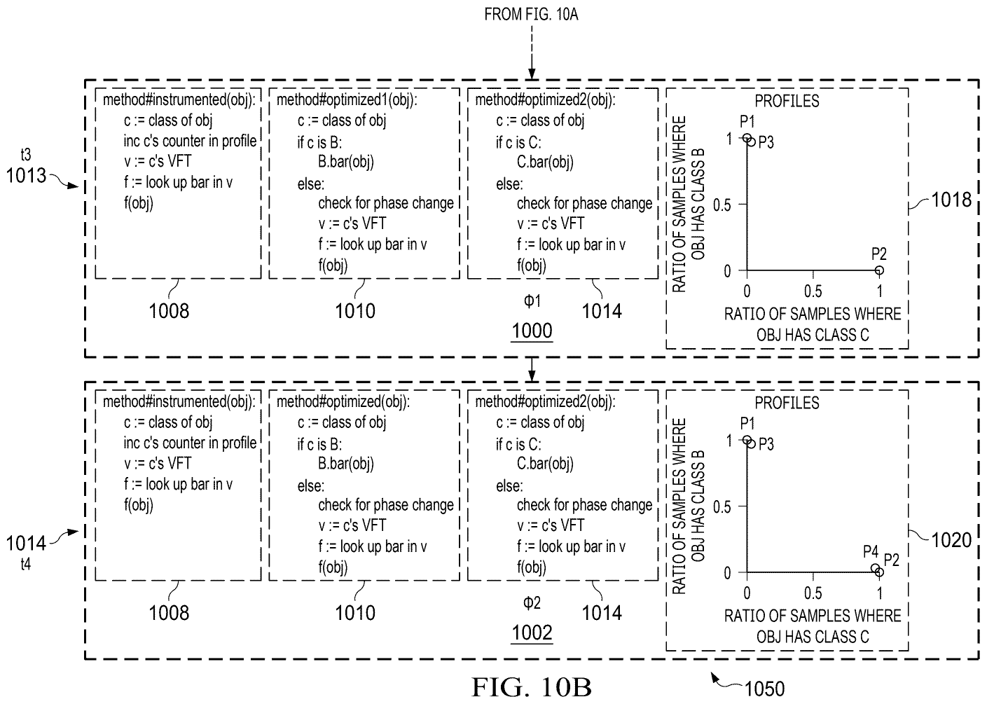

With reference next to FIGS. 10A and 10B, a dataflow diagram for phase changes is depicted in accordance with an illustrative embodiment. In this illustrative example, dataflow 1050 of phase changes in FIG. 10A-10B can be an example of phase change 222 in FIG. 2 and phase changes discussed in FIG. 3 and FIG. 4. Dataflow 1050 illustrates how the process in illustrative examples can compile and recompile a method in the application in FIG. 8.

In dataflow 1050, the application runs and phase Φ1 1000 is present at time t1 1001. In this example, time t1 1011 corresponds to the beginning of the loop in portion 802 in FIG. 8.

In this example, a phase change does not need to be detected for the initial phase in this dataflow 1050. In this example, t1 1011 can be the application beginning execution or the first time that the method is run. In case of a JIT compiler, t1 1011 can be the time when the control block decides that a “method” should be compiled.

In this illustrative example, phase Φ1 1000 is an example of phase Φ1 311 in FIG. 3.

At time t1 1011, instrumented body 1008 is generated for a method in the application. In this illustrative example, instrumented body 1008 can be an example of instrumented body 236 in FIG. 2. As depicted, instrumented body 1008 provides information about the behavior of this method when running the application. In this illustrative example, the profile information collected by running instrumented body 1008 is used to form first profile P1 for the application during phase Φ1 1000.

In this illustrative example, profile plot 1012 shows the first profile P1. In profile plot 1012, the first profile P1 indicates that the method is primarily called with the parameter “obj” having type “B” in the application during phase Φ1 1000.

In this example, the method is compiled with profile guided optimization using the profile information in the first profile P1 to form specialized body 1010. This specialized body optimizes performance of the application during phase Φ1 1000. For example, specialized body 1010 includes logic to determine whether the “obj” parameter for the method belongs to class “B” and directly calls method “bar( )” for class “B” when the “obj” parameter for the method belongs to class “B”.

Calls to this method are patched to call specialized body 1010 during phase Φ1 1000 after compilation is completed. In this illustrative example, specialized body 1010 can be an example of specialized body foo_phase Φ1( ) 411 in FIG. 4.

As depicted in dataflow 1050, a phase change occurs at time t2 1012. In this example, time t2 1012 corresponds to the beginning of the loop in portion 804 in FIG. 8.

In response to detecting this phase change, instrumented body 1008 is reused to select profile information about the behavior of this method while the application runs. In this illustrative example, the profile information collected by running instrumented body 1008 is used to form a second profile P2.

As depicted, profile plot 1016 shows the second profile P2 and the first profile P1. With profile plot 1016, the second profile P2 can be compared with the previously determined profile P1 to determine whether the specialized body generated in phase Φ1 1000 can be used to optimize performance for the application. In this illustrative example, the distance between two profiles on profile plot 1016 indicates an absence of a similarity between the two profiles. In profile plot 1016, the second profile P2 is not similar to profile P1. In other words, first profile P1 is not sufficiently close to second profile P2 in profile plot 1016 to be considered a match.

In this illustrative example, second profile P2 in profile plot 1016 indicates that the method is primarily called with the parameter “obj” having type “C” in the application.

As a result, a new phase is present. Phase Φ2 1002 is a second phase for the application. In this illustrative example, phase Φ2 1002 is an example of phase Φ2 312 in FIG. 3

In this example, the method is compiled with a profile guided optimization using the profile information in second profile P2 to form specialized body 1014. This specialized body is used to optimize performance for the application during phase Φ2 1002. Specialized body 1014 includes logic to determine whether the “obj” parameter for the method belongs to class “C” and directly calls method “bar( )” for class “C” when the “obj” parameter for the method belongs to class “C”.

Calls to the method are patched to call specialized body 1014 during phase Φ2 1002 after compilation is completed. In this illustrative example, specialized body 1014 can be an example of specialized body foo_phase Φ2( ) 412 in FIG. 4. In these examples, specialized body 1010 is not discarded but saved even though a new specialized body is created.

In dataflow 1050, the application has another phase change at time t3 1013. In this example, time t3 1013 corresponds to the beginning of the loop in portion 806 in FIG. 8.

In response to the phase change, instrumented body 1008 is reused to gather profile information about the behavior of the method in the application. In this illustrative example, the information provided by running instrumented body 1008. This running of instrumented body 1008 is used to collect current profile information for a third profile P3 for the application. Third profile P3 is used determine whether the phase has shifted back to phase Φ1 1000 or to another entirely new phase.

Profile plot 1018 shows the third profile P3 formed from the current profile information collected using instrumented body 1008. The plot also shows first profile P1 and second profile P2. As depicted, the third profile P3 is compared to first profile P1 and second profile P2 in profile plot 1018. In this illustrative example, third profile P3 in profile plot 1018 is sufficiently similar to first profile P1 for phase Φ1 1000 to be considered a match.

In this example, third profile P3 indicates that the method is also primarily called with the “obj” parameter having class “B”. Thus, the phase change at time t3 1013 is a shift from phase Φ2 1002 back to phase Φ1 1000 for the application. As a result, specialized body 1010 previously created for phase Φ1 1000 can be reused.

Calls to the method are patched to call specialized body 1010 during phase Φ1 1000 after compilation is completed. In this case, specialized body 1010 does not have to be recompiled, saving time and processing resources.

Next at time t4 1014, another phase change is detected. In this example, time t4 1014 is an example of the beginning of a loop in portion 808 in FIG. 8.

In response, instrumented body 1008 is used to collect profile information about the behavior of the method for the application. In this illustrative example, the current profile information collected by running instrumented body 1008 is used to form fourth profile P4 for the application.

As depicted, profile plot 1020 shows fourth profile P4 formed using information provided from running instrumented body 1008. This plot also depicts first profile P1, second profile P2, and third profile P3. As depicted, fourth profile P4 in profile plot 1020 can be compared to these previously determined profiles. This comparison can be made to determine whether a match is present enabling reusing one of the specialized bodies to optimize performance for the application in the current phase.

In this illustrative example, the fourth profile P4 in profile plot 1020 is sufficiently similar to second profile P2 for phase Φ2 1002 to be a match for profile P2. In other words, fourth profile P4 shows that the method is primarily called with the “obj” parameter having class “C”. Thus, in this example, the phase change is from phase Φ1 1000 to phase Φ2 1002.

As a result, specialized body 1014 can be reused. The application is patched such that calls to the method are directed to specialized body 1014 to optimize performance of the application during phase Φ2 1002. Then, a new specialized body does not have to be recompiled. In this case, specialized body 1014 previously compiled for phase Φ2 1002 can be used.

The illustration of components in FIG. 6-FIG. 10B are not meant to imply limitations to the manner in which an illustrative example can be implemented. For example, program instructions in FIG. 6-FIG. 10B can be written in other programming languages, mainframe languages, or any suitable machine understandable languages.

In addition, other numbers of phases can be present in other illustrative examples. For example, one phase, three phases, four phases, or some other number of phases can be present in other illustrative examples. If a third phase different from phase Φ1 1000 to phase Φ2 1002 are identified from the profile information collected in response to detecting a phase change, a new specialized body can be created using the profile information to optimize the execution of the application.

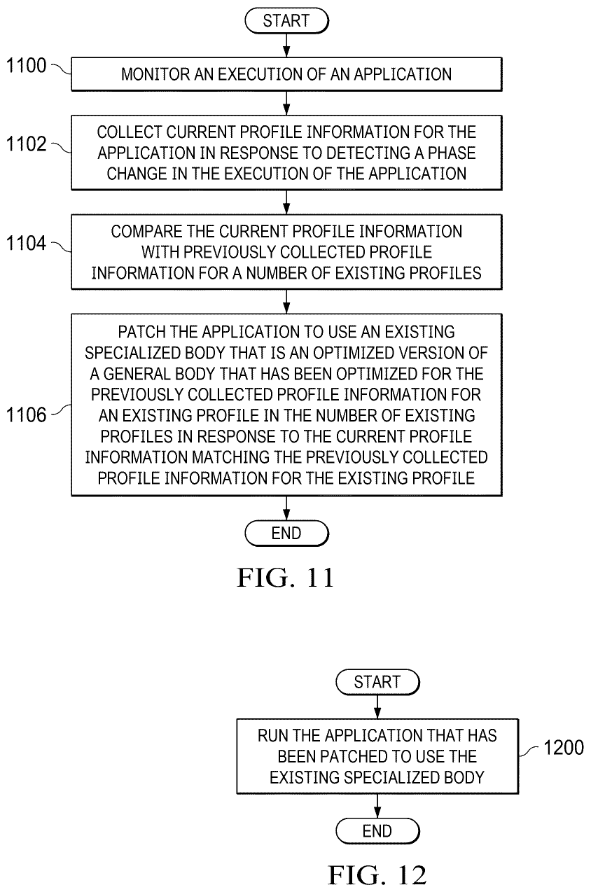

Turning next to FIG. 11, a flowchart of a process for application execution is depicted in accordance with an illustrative embodiment. The process in FIG. 11 can be implemented in hardware, software, or both. When implemented in software, the process can take the form of program instructions that are run by a processor set located in one or more hardware devices in one or more computer systems. For example, the process can be implemented in application manager 214 in computer system 212 in FIG. 2.

The process begins by monitoring an execution of an application (step 1100). The process collects current profile information for the application in response to detecting a phase change in the execution of the application (step 1102). In step 1102, current profile information can be for one body or multiple bodies in the application. Each body is a block or grouping of code that can be for a method, a function, a procedure, or other segment, code snippet, or construct.

The process compares the current profile information with previously collected profile information for a number of existing profiles (step 1104). In operation 1104, the current profile information can be for a body in which profile information has been collected. The previously collected profile from application for a number of existing profiles can be for a number of bodies that may be specialized versions of the body for which profile information has been obtained.

The process patches the application to use an existing specialized body that is an optimized version of a general body that has been optimized for the previously collected profile information for an existing profile in the number of existing profiles in response to the current profile information matching the previously collected profile information for the existing profile (step 1106). The process terminates thereafter.

Further, in FIG. 11, the processes called can be in response to different events other than a phase change. For example, a method may be called 1000 times and the application manager may decide to invoke a process based on this number of calls to the method in this flowchart rather than using on a phase change. This process can be initiated after the first time an optimization is performed for a general body.

With reference next to FIG. 12, a flowchart of a process for application execution is depicted in accordance with an illustrative embodiment. The process in this flowchart is an example of an additional step that can be performed with the steps in FIG. 11.

The process runs the application that has been patched to use the existing specialized body (step 1200). The process terminates thereafter.

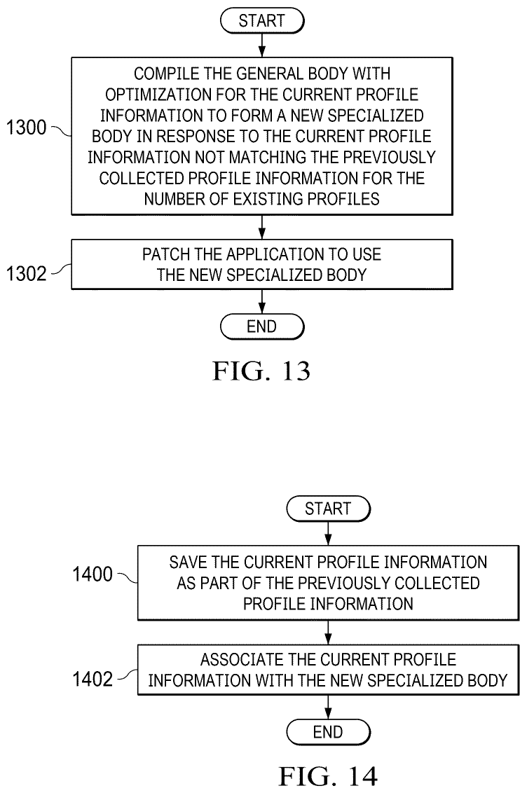

Next in FIG. 13, a flowchart of a process for creating a new specialized body for application is depicted in accordance with an illustrative embodiment. The process in this flowchart is an example of additional steps that can be performed with the steps in FIG. 11. This process can be performed when the current profile information does not match previously collected profile information for a number of existing profiles.

The process compiles the general body with optimization for the current profile information to form a new specialized body in response to the current profile information not matching the previously collected profile information for the number of existing profiles (step 1300). The process patches the application to use the new specialized body (operation 1302). The process terminates thereafter.

Turning to FIG. 14, a flowchart of a process for saving profile information is depicted in accordance with an illustrative embodiment. The process in this flowchart is an example of additional steps that can be performed with the steps in FIG. 13.

The process saves the current profile information as part of the previously collected profile information (step 1400). The process associates the current profile information with the new specialized body (step 1402). The process terminates thereafter.

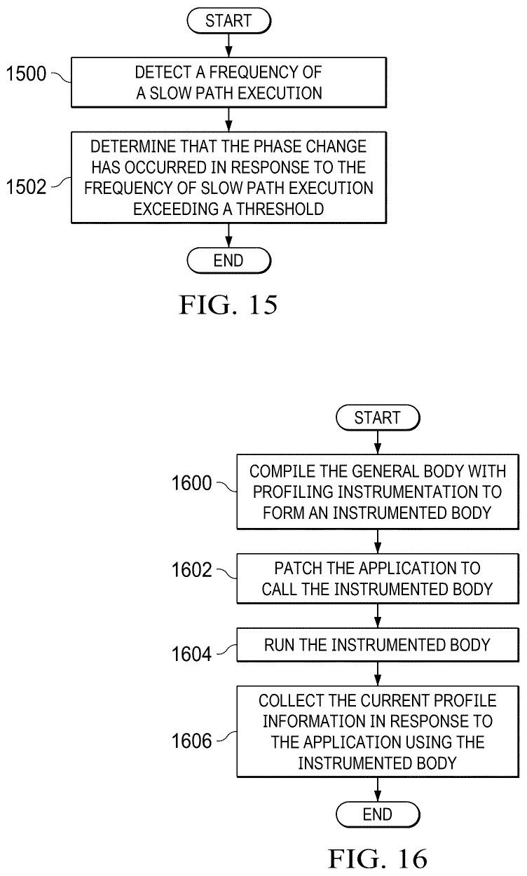

Next in FIG. 15, a flowchart of a process for detecting a phase change is depicted in accordance with an illustrative embodiment. The steps in FIG. 15 are an example of additional steps that can be performed with the steps in FIG. 11. This flowchart detects a phase change using software events in the form of a change in path frequency.

The process detects a frequency of a slow path execution (step 1500). The process determines that the phase change has occurred in response to the frequency of slow path execution exceeding a threshold (step 1502). The process terminates thereafter.

With reference now to FIG. 16, a flowchart of a process for collecting current profile information is depicted in accordance with an illustrative embodiment. The process in this flowchart is an example of an implementation of step 1102 in FIG. 11.

The process begins by compiling the general body with profiling instrumentation to form an instrumented body (step 1600). The process patches the application to call the instrumented body (step 1602). The process runs the instrumented body (step 1604).

The process collects the current profile information in response to the application using the instrumented body (step 1606). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

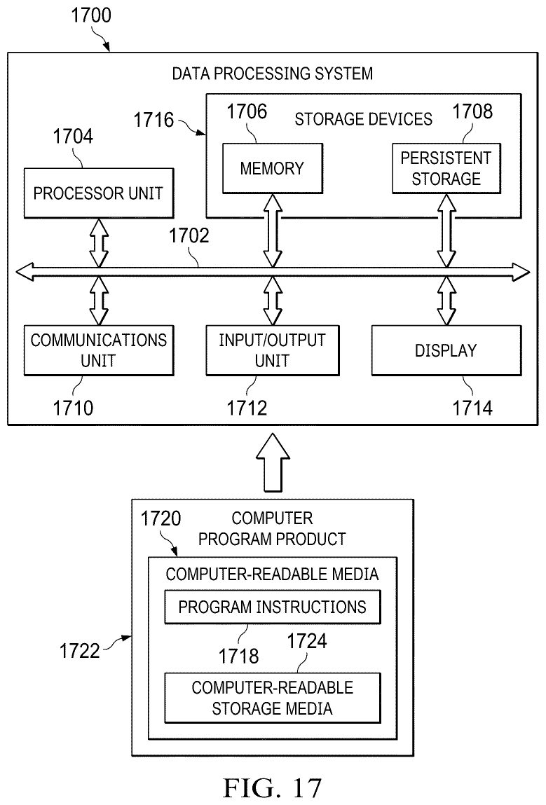

Turning now to FIG. 17, a block diagram of a data processing system is depicted in accordance with an illustrative embodiment. Data processing system 1700 can be used to implement computers and computing devices in computing environment 100 in FIG. 1. Data processing system 1700 can also be used to implement computer system 212 in FIG. 2. In this illustrative example, data processing system 1700 includes communications framework 1702, which provides communications between processor unit 1704, memory 1706, persistent storage 1708, communications unit 1710, input/output (I/O) unit 1712, and display 1714. In this example, communications framework 1702 takes the form of a bus system.

Processor unit 1704 serves to execute instructions for software that can be loaded into memory 1706. Processor unit 1704 includes one or more processors. For example, processor unit 1704 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1704 can be implemented using one or more heterogeneous processor systems in which a main processor is present with secondary processors on a single chip. As another illustrative example, processor unit 1704 can be a symmetric multi-processor system containing multiple processors of the same type on a single chip.

Memory 1706 and persistent storage 1708 are examples of storage devices 1716. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1716 may also be referred to as computer-readable storage devices in these illustrative examples. Memory 1706, in these examples, can be, for example, a random-access memory or any other suitable volatile or non-volatile storage device. Persistent storage 1708 may take various forms, depending on the particular implementation.

For example, persistent storage 1708 may contain one or more components or devices. For example, persistent storage 1708 can be a hard drive, a solid-state drive (SSD), a flash memory, a rewritable optical disk, a rewritable magnetic tape, or some combination of the above. The media used by persistent storage 1708 also can be removable. For example, a removable hard drive can be used for persistent storage 1708.

Communications unit 1710, in these illustrative examples, provides for communications with other data processing systems or devices. In these illustrative examples, communications unit 1710 is a network interface card.

Input/output unit 1712 allows for input and output of data with other devices that can be connected to data processing system 1700. For example, input/output unit 1712 may provide a connection for user input through at least one of a keyboard, a mouse, or some other suitable input device. Further, input/output unit 1712 may send output to a printer. Display 1714 provides a mechanism to display information to a user.

Instructions for at least one of the operating system, applications, or programs can be located in storage devices 1716, which are in communication with processor unit 1704 through communications framework 1702. The processes of the different embodiments can be performed by processor unit 1704 using computer-implemented instructions, which may be located in a memory, such as memory 1706.

These instructions are referred to as program instructions, computer usable program instructions, or computer-readable program instructions that can be read and executed by a processor in processor unit 1704. The program instructions in the different embodiments can be embodied on different physical or computer-readable storage media, such as memory 1706 or persistent storage 1708.

Program instructions 1718 are located in a functional form on computer-readable media 1720 that is selectively removable and can be loaded onto or transferred to data processing system 1700 for execution by processor unit 1704. Program instructions 1718 and computer-readable media 1720 form computer program product 1722 in these illustrative examples. In the illustrative example, computer-readable media 1720 is computer-readable storage media 1724.

Computer-readable storage media 1724 is a physical or tangible storage device used to store program instructions 1718 rather than a medium that propagates or transmits program instructions 1718. Computer-readable storage media 1724, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1718 can be transferred to data processing system 1700 using a computer-readable signal media. The computer-readable signal media are signals and can be, for example, a propagated data signal containing program instructions 1718. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1720” can be singular or plural. For example, program instructions 1718 can be located in computer-readable media 1720 in the form of a single storage device or system. In another example, program instructions 1718 can be located in computer-readable media 1720 that is distributed in multiple data processing systems. In other words, some instructions in program instructions 1718 can be located in one data processing system while other instructions in program instructions 1718 can be located in one data processing system. For example, a portion of program instructions 1718 can be located in computer-readable media 1720 in a server computer while another portion of program instructions 1718 can be located in computer-readable media 1720 located in a set of client computers.

The different components illustrated for data processing system 1700 are not meant to provide architectural limitations to the manner in which different embodiments can be implemented. In some illustrative examples, one or more of the components may be incorporated in or otherwise form a portion of, another component. For example, memory 1706, or portions thereof, may be incorporated in processor unit 1704 in some illustrative examples. In other examples, more than one processor unit can be present. The different illustrative embodiments can be implemented in a data processing system including components in addition to or in place of those illustrated for data processing system 1700. Other components shown in FIG. 17 can be varied from the illustrative examples shown. The different embodiments can be implemented using any hardware device or system capable of running program instructions 1718.

Thus, illustrative embodiments of the present invention provide a computer implemented method, computer system, and computer program product for managing an application execution. A processor set monitors an execution of an application. The processor set collects current profile information for the application in response to detecting a phase change in the execution of the application. The processor set compares the current profile information with previously collected profile information for a number of existing profiles. The processor set patches the application to use an existing specialized body that is an optimized version of a general body that has been optimized for the previously collected profile information for an existing profile in the number of existing profiles in response to the current profile information matching the previously collected profile information for the existing profile. According to other illustrative embodiments, a computer system and a computer program product for managing application execution are provided.

In the different illustrative examples, the process continuously monitors for a phase change based on a change in behavior of the application. Profile information is collected in a new profile for the phase. A determination is made as to whether the new profile matches an existing profile from a prior phase. If a match is present, a specialized body optimized for the prior phase matching the existing profile is used. Otherwise, if a match is absent, then a new specialized body can be generated with optimizations based on the profile information in the new profile. The optimization in these examples can be performed without having to recompile for specialized bodies for phases that have occurred previously in the application.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for managing application execution, the computer implemented method comprising:
monitoring, by a processor set, an execution of an application;
collecting, by the processor set, current profile information for the application in response to detecting a phase change in the execution of the application;
comparing, by the processor set, the current profile information with previously collected profile information for a number of existing profiles; and
patching, by the processor set, the application to use an existing specialized body that is an optimized version of a general body that has been optimized for the previously collected profile information for an existing profile in the number of existing profiles in response to the current profile information matching the previously collected profile information for the existing profile.

2. The computer implemented method of claim 1 further comprising:
compiling, by the processor set, the general body with optimization for the current profile information to form a new specialized body in response to the current profile information not matching the previously collected profile information for the number of existing profiles; and
patching, by the processor set, the application to use the new specialized body.

3. The computer implemented method of claim 2 further comprising:
saving, by the processor set, the current profile information as part of the previously collected profile information; and
associating, by the processor set, the current profile information with the new specialized body.

4. The computer implemented method of claim 1 further comprising:
running, by the processor set, the application that has been patched to use the existing specialized body.

5. The computer implemented method of claim 1 further comprising:
detecting a frequency of a slow path execution; and
determining that the phase change has occurred in response to the frequency of slow path execution exceeding a threshold.

6. The computer implemented method of claim 1, wherein collecting, by the processor set, the current profile information comprises:
compiling, by the processor set, the general body with profiling instrumentation to form an instrumented body;
patching, by the processor set, the application to call the instrumented body;
running, by the processor set, the application using the instrumented body; and
collecting, by the processor set, the current profile information in response to the application using the instrumented body.

7. The computer implemented method of claim 1, wherein the current profile information and the previously collected profile information comprises at least one of a function call, a branch, a system call, or an expected value.

8. The computer implemented method of claim 1, wherein the phase change is indicated by at least one of a software event, a hardware event, or an external condition.

9. A computer system comprising:
a processor set; a set of one or more computer-readable storage media; and
program instructions, collectively stored in the set of one or more storage media, for causing the processor set to perform the following computer operations:
monitor an execution of an application;
collect current profile information for the application in response to detecting a phase change in the execution of the application;
compare the current profile information with previously collected profile information for a number of existing profiles; and
patch the application to use an existing specialized body that is an optimized version of a general body that has been optimized for the previously collected profile information for an existing profile in the number of existing profiles in response to the current profile information matching the previously collected profile information for the existing profile.

10. The computer system of claim 9, wherein the program instructions, collectively stored in the set of one or more storage media, further causes the processor set to perform the following computer operations:
compile, by the processor set, the general body with optimization for the current profile information to form a new specialized body in response to the current profile information not matching the previously collected profile information for the number of existing profiles; and
patching, by the processor set, the application to use the new specialized body.

11. The computer system of claim 10, wherein the program instructions, collectively stored in the set of one or more storage media, further causes the processor set to perform the following computer operations:
save the current profile information as part of the previously collected profile information; and
associate the current profile information with the new specialized body.

12. The computer system of claim 9, wherein the program instructions, collectively stored in the set of one or more storage media, further causes the processor set to perform the following computer operations:
run the application that has been patched to use the existing specialized body.

13. The computer system of claim 9, wherein the program instructions, collectively stored in the set of one or more storage media, further causes the processor set to perform the following computer operations:
detect a frequency of a slow path execution; and
determine that the phase change has occurred in response to the frequency of slow path execution exceeding a threshold.

14. The computer system of claim 9, wherein in collecting the current profile information, wherein the program instructions, collectively stored in the set of one or more storage media, causes the processor set to perform the following computer operations:
compile the general body with profiling instrumentation to form an instrumented body;
patch the application to call the instrumented body;
run the application using the instrumented body; and
collect the current profile information in response to running the application using the instrumented body.

15. The computer system of claim 9, wherein the current profile information and the previously collected profile information comprises at least one of a function call, a branch, a system call, or an expected value.

16. The computer system of claim 9, wherein the phase change is indicated by at least one of a software event, a hardware event, or an external condition.

17. A computer program product for managing application execution, the computer program product comprising:
a set of one or more computer-readable storage media;
program instructions, collectively stored in the set of one or more storage media, for causing a processor set to perform the following computer operations:
monitor an execution of an application;
collect current profile information for the application in response to detecting a phase change in the execution of the application;
compare the current profile information with previously collected profile information for a number of existing profiles; and
patch the application to use an existing specialized body that is an optimized version of a general body that has been optimized for the previously collected profile information for an existing profile in the number of existing profiles in response to the current profile information matching the previously collected profile information for the existing profile.

18. The computer program product of claim 17, wherein the program instructions, collectively stored in the set of one or more storage media further cause the processor set to:
compile the general body with optimization for the current profile information to form a new specialized body in response to the current profile information not matching the previously collected profile information for the number of existing profiles; and
patch the application to use the new specialized body.

19. The computer program product of claim 18, wherein the program instructions, collectively stored in the set of one or more storage media further cause the processor set to:
save the current profile information as part of the previously collected profile information; and
associate the current profile information with the new specialized body.

20. The computer program product of claim 9 further comprising:
running, by the processor set, the application that has been patched to use the existing specialized body.
